(19) United States
(12) Patent Application Publication
(10) Pub. No.: US 2018/0187972 A1
(43) Pub. Date: Jul. 5, 2018

(54) Device for Separating Solid Carbon Dioxide from a Suspension

(71) Applicants: Larry Baxter, Orem, UT (US); Andrew Baxter, Spanish Fork, UT (US); David Frankman, Provo, UT (US); Skyler Chamberlain, Provo, UT (US); Kyler Stitt, Lindon, UT (US)

(72) Inventors: Larry Baxter, Orem, UT (US); Andrew Baxter, Spanish Fork, UT (US); David Frankman, Provo, UT (US); Skyler Chamberlain, Provo, UT (US); Kyler Stitt, Lindon, UT (US)

(21) Appl. No.: 15/399,265

(22) Filed: Jan. 5, 2017

(51) Int. Cl. F25J 3/08; B01D 29/23; B01D 35/147; B01D 35/18; B01D 29/58; B01D 29/64

(52) U.S. Cl. CPC F25J 3/08; B01D 29/23; B01D 35/1475; B01D 35/18; F25J 2215/80; B01D 29/6476; B01D 29/6484; F25J 2205/84; F25J 2270/902; B01D 29/58

(57) ABSTRACT

An apparatus for separating solid CO2 suspended or entrained in a liquid is disclosed. The apparatus comprises a housing with an interior and an exterior, a filter located within the interior of the housing, a compactor contained within the interior of the housing that compacts the solid CO2 against the filter to form compacted solid CO2, and a sealed system cooling device in thermal contact with the liquid, the solid CO2, the compacted solid CO2 , or the filter within the housing. The sealed system cooling device may receive temperature feedback and be controlled by a temperature of the liquid. The sealed system cooling device may be partially controlled by a pressure within the interior of the housing. The sealed system cooling device may be partially controlled by a pressure of the compacted solid CO2 and a current consumed by a motor of the compactor.

This invention was made with government support under DE-FE0028697 awarded by The Department of Energy. The government has certain rights in the invention.

### BACKGROUND

### Field of the Invention

The present invention relates to separation of solid CO₂ (carbon dioxide) suspended in liquids as in a slurry or suspension. Our immediate interest is in a slurry or suspension of solid CO₂ particles suspended in a liquid at temperatures below ambient, but this process has much broader application.

### Related Technology

As cold processing technology becomes more prevalent, new devices for separating solid CO₂ from liquids in a cold suspension are needed.

United States patent publication number 2012/0180657 to Monereau et al. teaches a method for producing at least one gas having a low CO₂ content and at least one fluid having a high CO₂ content. This disclosure is pertinent and could benefit from separation methods disclosed herein and is hereby incorporated by reference in its entirety for all that it teaches.

United States patent publication number 2014/0144178 to Terrien et al. teaches optimized heat exchange in a CO₂ de-sublimation process. This disclosure is pertinent and could benefit from separation methods disclosed herein and is hereby incorporated by reference in its entirety for all that it teaches.

United States patent publication number 2016/0290714 to Baxter et al. teaches optimized heat exchange in a CO₂ de-sublimation process. This disclosure is pertinent and could benefit from separation methods disclosed herein and is hereby incorporated by reference in its entirety for all that it teaches.

### SUMMARY

An apparatus for separating solid CO₂ (carbon dioxide) suspended or entrained in a liquid is disclosed. The apparatus comprises a housing with an interior and an exterior, a filter located within the interior of the housing, a compactor contained within the interior of the housing that compacts the solid CO₂ against the filter to form compacted solid CO₂, and a sealed system cooling device in thermal contact with the liquid. The sealed system cooling device may receive temperature feedback and be controlled by a temperature of the liquid. The sealed system cooling device may be partially controlled by a pressure within the interior of the housing. The sealed system cooling device may be partially controlled by a pressure of the compacted solid CO₂ and a current consumed by a motor of the compactor. The solid CO₂ of the suspension may include carbon dioxide. The sealed system cooling device may circulate fluid to provide cooling to the liquid of the suspension. The filter may be constructed at least partially from one or more of: mesh, stainless steel, metal, ceramic, carbon, fibrous materials, plastic, diamond, or an interstitially formed material. The sealed system cooling device may assist in keeping the solid CO₂ or liquid at temperatures below −50° C. The solid CO₂ may be compacted by the compactor using a motor by one or more screws, augers, pistons, tapered wedges, or combinations thereof. The filter housing may provide a frame which connects an input port to a first side of the filter. The sealed system cooling device may be located within the interior of the housing. The sealed system cooling device may be an integral part of the housing. The sealed system cooling device may be in thermal contact with the exterior of the housing. The sealed system cooling device may be wrapped around the filter. The sealed system cooling device may be wrapped around the housing. The filter may be two or more mesh filters sintered together. The two or more mesh filters may each have a filtering size between 70 microns and 2 microns. The housing may comprise a gas discharge port. The gas discharge port may partially control a pressure within the housing. The gas discharge port may feed into a process gas input.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a prospective view of a solid CO₂ separation apparatus in accordance with an embodiment of the invention;

FIG. 2 shows a partial cross-sectional side view of a solid CO₂ separation apparatus in accordance with an embodiment of the invention;

FIG. 3 shows a prospective view of a solid CO₂ separation filter in accordance with an embodiment of the invention;

FIG. 4 shows a functional flow of a solid CO₂ separation device in accordance with an embodiment of the invention;

FIG. 5 shows a partial cross-sectional side view of a solid CO₂ separation apparatus in accordance with an embodiment of the invention;

FIG. 6 shows a functional flow of a solid CO₂ separation device in accordance with an embodiment of the invention;

FIG. 7 shows a functional flow of a solid CO₂ separation device in accordance with an embodiment of the invention;

FIG. 8 shows two mesh filters in accordance with an embodiment of the invention;

FIG. 9 shows two or more sintered mesh filters in accordance with an embodiment of the invention; and

FIG. 10 shows a filter frame with an inner mesh filter in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

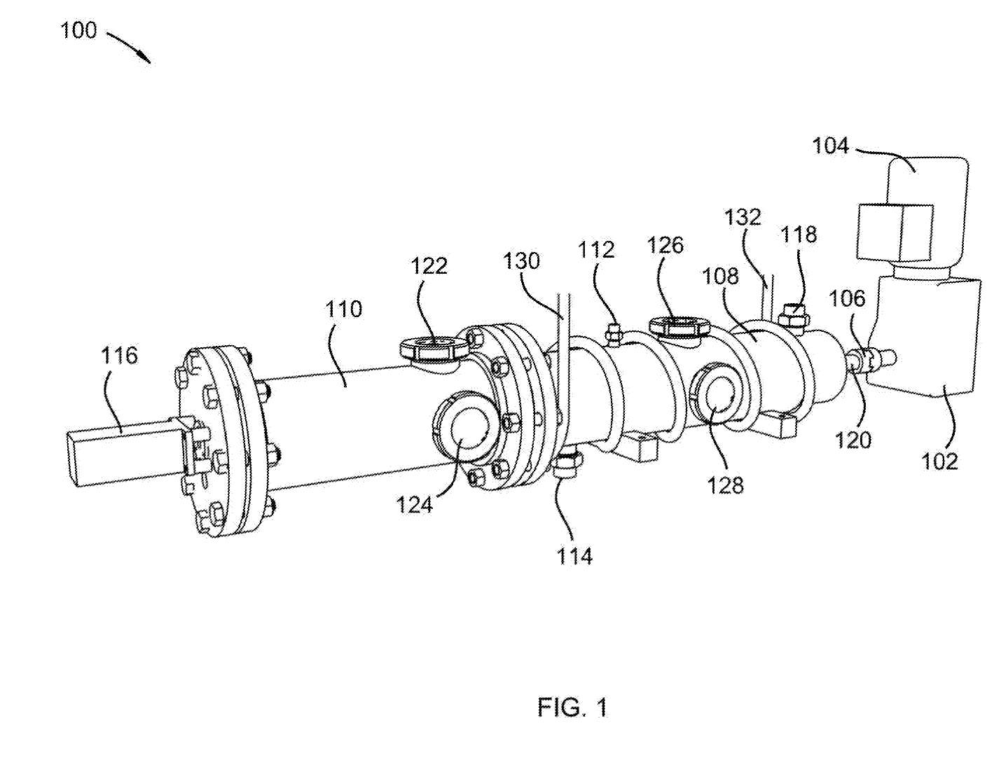

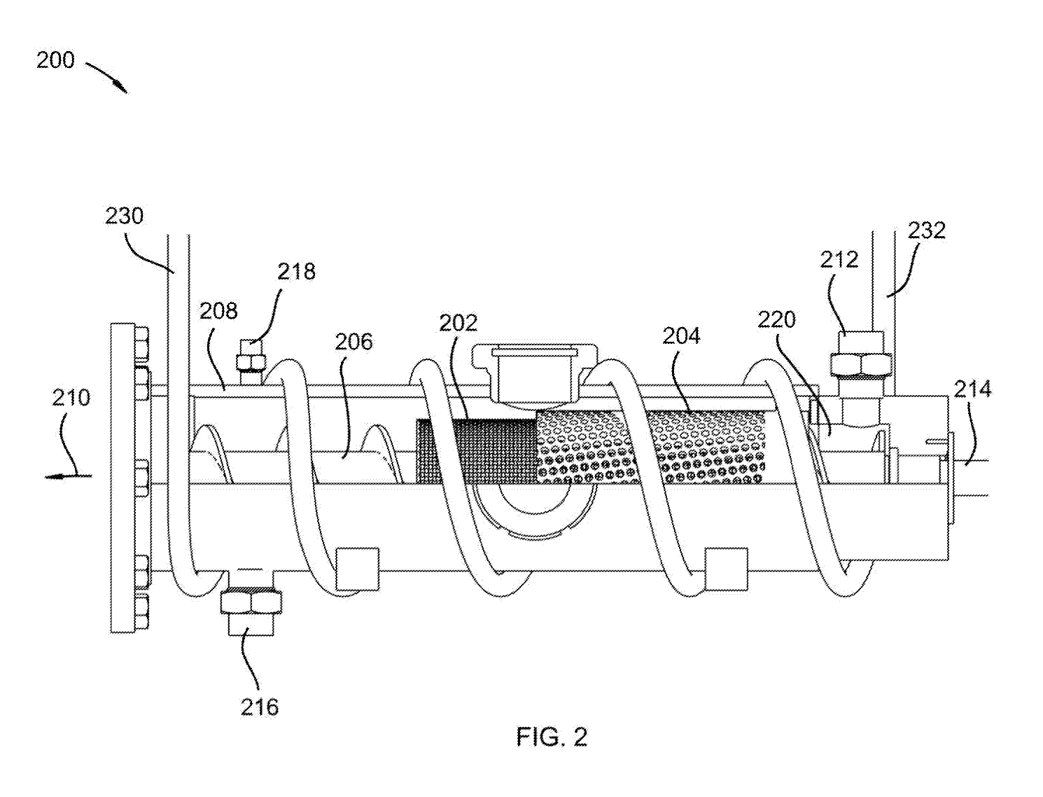

Referring to FIG. 1, a solid CO₂ separation apparatus 100 is shown. Apparatus 100 contains a slurry or suspension input port 118 attached to a filter housing 108. Input 118 receives cold solid CO₂ suspended in a liquid at temperatures below the solid CO₂ melting or dissolution point, which is below −56.6° C. in the case of CO₂. A slurry or suspension may be formed by cooling of one or more slurry or suspension liquids to temperatures below −56° C. with one or more condensable materials present in the liquid, the condensable materials forming solid CO₂ at temperatures below −56° C. The condensable materials may be post-combustion materials or flu gas materials. Well-known refrigeration processes may be used to cool the slurry or suspension liquids to temperatures below −56° C. Motor 104 may be used in combination with gear box 102, drive coupler 106, and drive shaft 120 to compact or compress solid CO₂ within the slurry or suspension on a first side of a filter (shown in FIG. 2) within filter housing 108. Process ports 126, 128 are shown attached to filter housing 108. Process ports 126, 128 may be used for process monitoring, process instrumentation, process sensors, etc. Process sensors may include temperature sensors, pressure sensors, vibration sensors, ultrasonic sensors, level sensors, photo sensors, cameras, etc. Filter housing 108 forms a frame which supports input port 118, liquid discharge port 114 and gas discharge 112. The frame of filter housing 108 may rigidly connect to solid CO₂ pressure chamber 110 and solid CO₂ regulator actuator 116. Solid CO₂ separation apparatus 100 may be configured to melt separated solid CO₂ within pressure chamber 110. A sealed system cooling device 130, 132 may be a refrigerated coil in thermal contact with liquids within housing 108. A sealed system cooling device may be defined as a “sealed coil” or a “sealed jacket” or a “sealed area” which is not in fluid contact with CO₂. The refrigerated coil (sealed system cooling device) may transport a cryogenically cooled fluid cooled to temperatures below −56° C. or to expand a liquid refrigerant such as Hexafluoroethane, Trifluoromethane, Ethane, Ethylene, Tetrafluoromethane, Methane, Argon, Nitrogen, Neon, Helium, Hydrogen, or any other low boiling point refrigerant. The sealed system cooling device (coil) may be fused to an exterior of housing 108, integrally formed into a side wall of housing 108, or inside of housing 108. The sealed system cooling device may help to keep the solid CO₂ or liquid at or below a melting point of the solid CO₂.

Referring to FIG. 2, a cross sectional view of filter housing 108, of FIG. 1, is shown generally at 200. A filter comprising portions 204 and 202 may be housed within filter housing 208 and may surround a solid CO₂ compacting mechanism 206. Solid CO₂ compacting mechanism 206 may be driven by a rotational drive shaft 220. Solid CO₂ compacting mechanism 206 is shown as a helical screw compactor, but other know mechanical solid CO₂ compactor mechanisms such as pistons, presses, or tapered wedges may be used. Filter portion 202 and/or 204 may be formed as a flat plate or other shape which allow filtering and compacting of solid CO₂ of a slurry or suspension. Filter portion 202 may be designed to filter particles between 2 micons to 70 microns or sizes greater than 70 microns if the particles remain contained on the first side of the filter. Filter portion 204 may be formed to support internal pressures up to 15 Bar created by solid CO₂ compacting mechanism 206. Filter housing 208 may form a frame which provides a direct conduit for slurry or suspension to be introduced through input port 218 into area 216 in direct contact with compacting mechanism 206 on a first side of filter portion 202. Some of the liquid contained within the slurry or suspension may immediately be transferred through a first (inner) side of filter portion 202 to a second (outer) portion of filter 202 and through filter portion 204 and out of liquid discharge port 214. Other liquid will be trapped in solid CO₂ of the slurry or suspension and will be released as the solid CO₂ is compacted by the solid CO₂ compacted mechanism 206 and forced into a solid CO₂ regulator and into pressure chamber 110, 210. A solid CO₂ pressure regulator located between filter housing 208 and pressure chamber 110, 210 provides back pressure on the solid CO₂ and regulates a solid CO₂ pressure on the first side of the filter portion 202 at pressures between 4 Bar to 15 Bar depending on process conditions. Gas discharge port 212 may be used to discharge gas and regulate a pressure on the second side of filter 202, 204. The pressure on the second side of filter 202, 204 may be a negative or positive pressure. A gas flow device may be operably connected to Gas discharge port 212 allowing for both positive and negative pressures to be generated on the second side of filter 202, 204. Pressures on the second side of Filter 202,204 may also oscillate between positive and negative pressures allowing gasses and liquid trapped within the solid CO₂ to be released and discharged out of Filter housing 108, 208. Filter 202, 204 may be formed of multiple filters such as sintered mesh filters or may be formed as one filter. The filter may be formed of solid ceramic or partially formed of ceramic. A diamond filter may be created by interstitially formed pores with filtering dimensions between 2 microns and 70 microns. Other known filters, having the capacity to separate small solid particles from a liquid while under pressure, may also be used. A sealed system cooling device 230, 232 may be a refrigerated coil in thermal contact with liquids within housing 208. The refrigerated coil (sealed system cooling device) may transport a cryogenically cooled fluid cooled to temperatures below −56° C. or to expand a liquid refrigerant such as Hexafluoroethane, Trifluoromethane, Ethane, Ethylene, Tetrafluoromethane, Methane, Argon, Nitrogen, Neon, Helium, Hydrogen, or any other low boiling point refrigerant. The sealed system cooling device (coil) may be fused to an exterior of housing 208, integrally formed into a side wall of housing 208, or inside of housing 208. The sealed system cooling device may help to keep the solid CO2 or liquid at or below a melting point of the solid CO2.

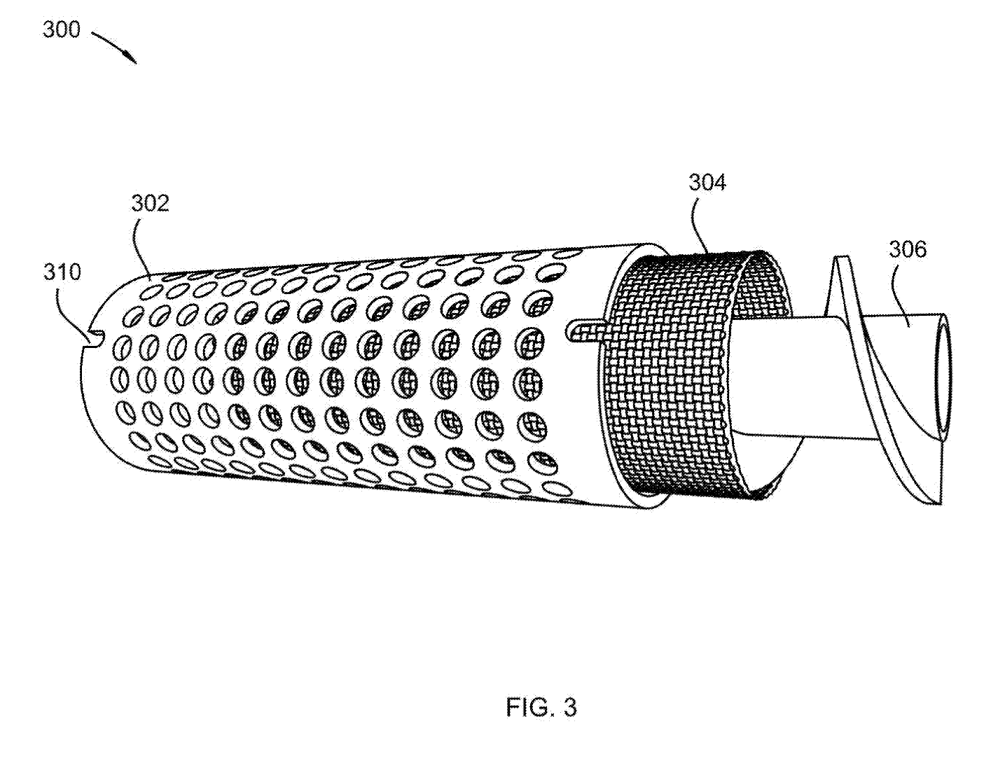

Referring to FIG. 3, a filter 300 is shown having a filter frame 302. Filter frame may have rotational locking grooves 310 on each end of the frame 302 to keep the frame from rotating as screw 306 rotates within filter 300. Filter 300 may include a sintered mesh filter 304 with filtering capabilities between 2 and 70 microns attached to an inner surface of frame 302. FIG. 3 shows, for convenience, filter 300 pulled apart into frame section 302 and mesh filter section 304, but frame section and mesh filter section 304 may be welded, brazed, or glued together to provide a rigid filter 300. Filter 300 may be designed to withstand pressures up to 15 Bar. Screw auger 306 may be rotated by a motor 104 and gear box 102 (shown in FIG. 1) to compress solid CO₂ inside of filter 300 and out of a pressure regulating solid CO₂ discharge port 510 into a pressure vessel 528.

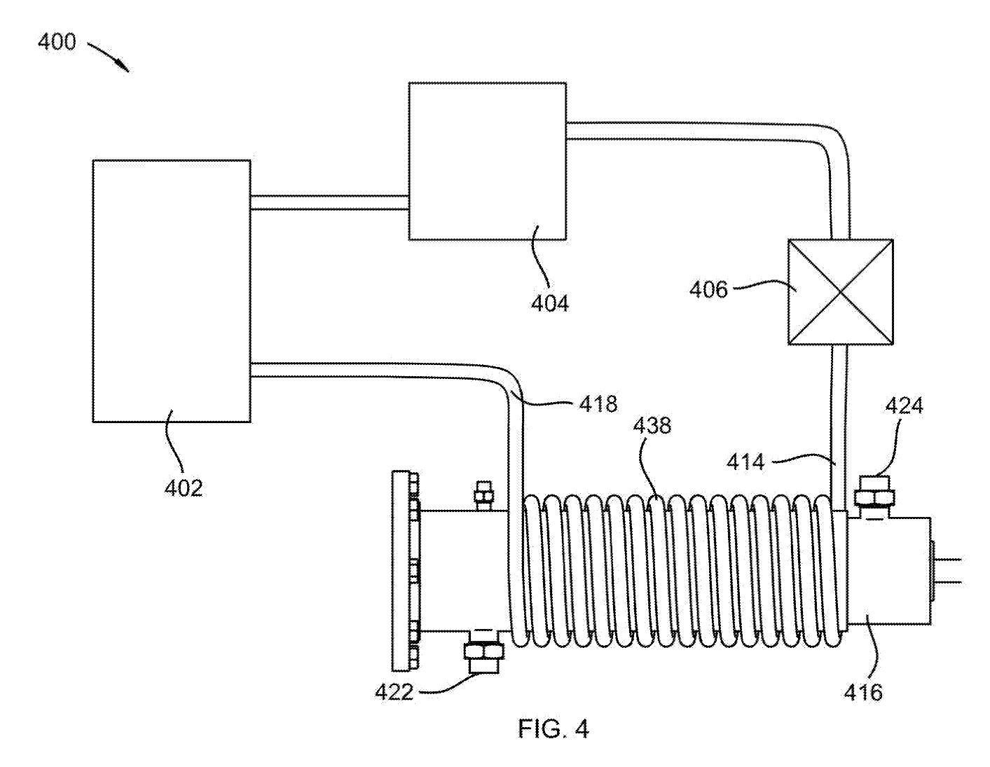

Referring to FIG. 4, in one embodiment, a cryogenic cooler 402 cools a cryogenic liquid and pump 404 circulates the cooled liquid through a sealed system cooling device 438 wrapped around housing 416 by way of inlet 414 and outlet 418. Metering valve 406 controls a flow of fluid through coil sealed system cooling device 438. Metering valve 406 may be electrically controllable or may be a mechanically controlled by spring pressure or by thermostatic capillary force. A flow thorough cooling coil device 438 may determine a temperature within housing 416 and a temperature of liquid leaving liquid discharge port 422. A temperature sensor may be in contact with liquid leaving discharge port 422 to provide feedback for pump 404 and metering valve 406. Sealed system cooling device 438 may provide heat transfer from solid CO₂ and/or liquids entering input port 424. The sealed system cooling device 438 may help to keep the solid CO2 or liquid at or below a melting point of the solid CO2.

In another embodiment, compressor 402 provides a low pressure to evaporator outlet 418 and provides a compressed hot gas refrigerant to condenser 404. Condenser 404 may transfer heat from the hot gas refrigerant and condense the refrigerant into a cooled liquid refrigerant at metering device 406. Metering device 406 may provide a pressure drop into evaporator sealed system cooling device 438 by way of inlet 414 allowing rapid expansion of liquid refrigerant into a gas form within sealed system cooling device 438. As the liquid refrigerant boils off heat is absorbed into the gas by transferring heat from housing 416 and liquid and solid CO₂ within housing 416. Refrigerants or mixtures of refrigerants such as Hexafluoroethane, Trifluoromethane, Ethane, Ethylene, Tetrafluoromethane, Methane, Argon, Nitrogen, Neon, Helium, Hydrogen, or any other low boiling point refrigerants may be used. The sealed system cooling device 438 may help to keep the solid CO₂ or liquid at or below a melting point of the solid CO₂.

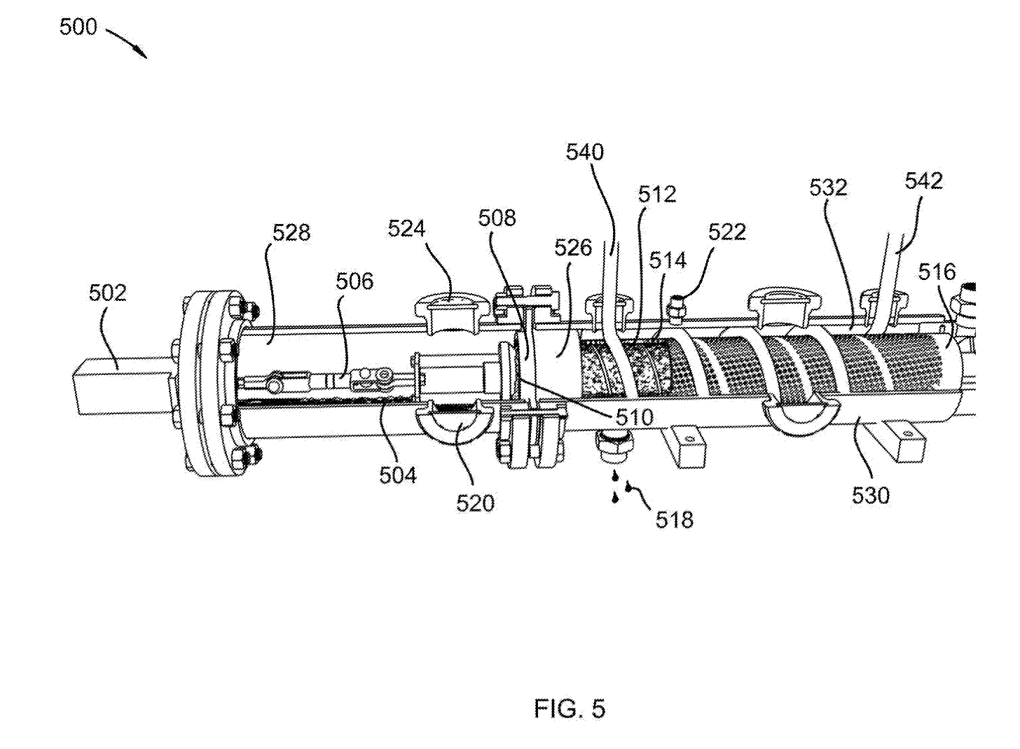

Referring to FIG. 5, a prospective cross-sectional view of a solid CO₂ separation apparatus in accordance with an embodiment of the invention is shown at 500. A cross-section of pressure chamber 110 of FIG. 1 is shown with an inner chamber 528 and process ports 524 and 520. Inner chamber 528 receives compacted solid CO₂ 512 through solid CO₂ pressure regulator opening 510. Compacted solid CO₂ 512 are compressed solid CO₂ resulting from post-combustion material or flu gas material desublimating or condensing in a cold liquid and being pressed together by screw auger 514 inside of filter 516. Filter 516, may be a ceramic filter or a wire mesh filter with a filtering size between 2 microns to 70 microns. As the solid CO₂ is compacted, liquid and gas is released from the solid CO₂ and discharged through liquid discharge port 518 and gas discharge port 522. The solid CO₂ pressure regulator may comprise a first and second mated valve 530 and 526 which control a speed by which solid CO₂ 512 enter pressure chamber 528. The solid CO₂ pressure regulator may additionally comprise an actuator 502 and an actuator arm 506. Actuator 502 may be pneumatic, hydraulic, hydronic, or a motorized actuator. Actuator 502 may comprise a pressure sensor for detecting a pressure placed on valve sections 530 and 526. The pressure sensor may be a strain gage device or other differential pressure device as is known in the art. Actuator 502 may be directly connected to actuator arm 506 and move arm 506 to control a back pressure that allows solid CO₂ 512 to be compacted. Solid CO₂ 512 when discharged into pressure chamber 528 may be melted to form a liquid 504 within chamber 528. Liquid formed by melting solid CO₂ in chamber 528 may be liquid post-combustion materials or flu gas materials such as carbon dioxide, nitrogen, oxygen, or combinations of any post-combustion material condensed into a slurry. Liquid 504 within chamber 528 may be removed or transferred by way of process ports 520 and 524. Process ports 520 and 524 may also be used to obtain process temperatures, pressures, and content level readings. Temperature sensors, pressure sensors, level sensors, etc., may be used to obtain and continuously monitor process conditions within chamber 528. Heat may be intentionally transferred to solid CO₂ within chamber 528 to melt solid CO₂ and transfer heat from liquid from 518 before liquid 518 is returned to form more slurry. This may be accomplished by a refrigeration process or by direct heat transfer to the liquid or to a condenser of a refrigerated cooling process. Heat may also be collected by pre-cooling the post-combustion materials which are condensed into the slurry before adding the post-combustion materials to the slurry for condensation into a solid or desublimation.

A sealed system cooling device 540, 542 may be a refrigerated coil in thermal contact with liquids within housing 530 to cool the liquids. The refrigerated coil (sealed system cooling device) may transport a cryogenically cooled fluid cooled to temperatures below −56° C. or to expand a liquid refrigerant such as Hexafluoroethane, Trifluoromethane, Ethane, Ethylene, Tetrafluoromethane, Methane, Argon, Nitrogen, Neon, Helium, Hydrogen, a combination thereof, or any other low boiling point refrigerant. The sealed system cooling device (coil) may be fused to an exterior of filter 516, wrapped around an exterior of filter 516, integrally formed into a side wall of filter 516, integrally formed into a side wall of housing 530, or attached to an inside of housing 530. The sealed system cooling device may help to keep the solid CO₂ or liquid at or below a melting point of the solid CO₂.

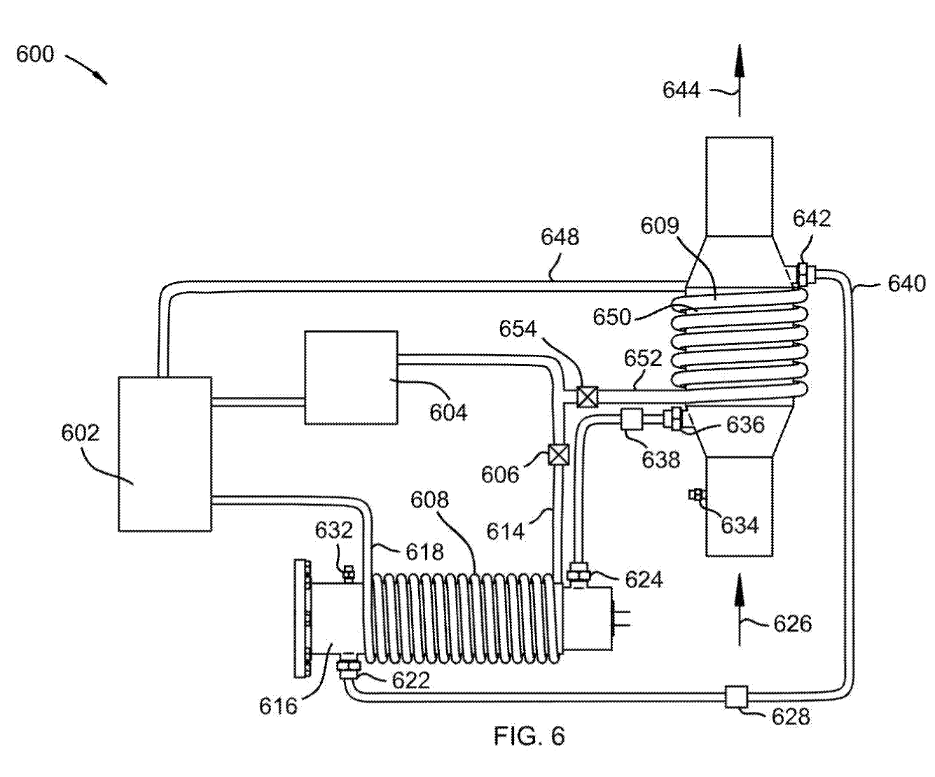

Referring to FIG. 6, in one embodiment, a cryogenic cooler 602 cools a liquid, and pump 604 circulates the cooled liquid through a sealed system cooling device 608 wrapped around housing 616 by way of inlet 614 and outlet 618; and provides cooling to a bubbler tank 650 by way of coil ends 648 and 652 of cooling coil device 609. Bubbler tank 650 may store cooled liquid at or near atmospheric pressures for desublimating flue gasses 626 as bubbled through cooled liquid stored and circulated through Bubbler tank 650 by way of inlet 640 and outlet 636. As post-combustion gases 626 pass through bubbler tank 650, condensable materials within the post-combustion gases 626 are desublimated and discharged through outlet 636 and through slurry pump 638 into inlet 624. Solid CO₂ compactor 616 then separates the solid CO₂ from the liquids and the liquids are cooled by the sealed system cooling device coil wrapped around housing 616 and the cooled liquid returns to the cooled bubbler tank 650. Metering valves 606 and 654 may control a flow of fluid through the cooling coil devices 608 and 609 in thermal contact with the bubbler tank 650 and the solid CO₂ compactor 616. Metering valves 606 and 654 may be electrically controllable or may be a mechanically controlled by spring pressure or by thermostatic capillary force. A flow thorough cooling coil device 608 and 609 may determine a temperature within housing 616, 650 and a temperature of liquid leaving liquid discharge ports 622 and 636. A temperature sensor may be in contact with liquid leaving discharge ports 622 and 636 to provide feedback for pumps 638,628 and metering valves 606 and 654. Sealed system cooling devices 608 and 609 may provide heat transfer from solid CO₂ and/or liquids entering input ports 624 and 642. The sealed system cooling devices 608 and 609 may help to keep the solid CO₂ or liquid at or below a melting point of the solid CO₂.

In another embodiment, compressor 602 provides a low pressure to evaporator outlets 618, 648 and provides a compressed hot gas refrigerant to condenser 604. Condenser 604 may transfer heat from the hot gas refrigerant and condense the refrigerant into a cooled liquid refrigerant at metering devices 606, 654. Metering devices 606, 654 may provide a pressure drop into evaporator sealed system cooling devices 608, 609 by way of inlets 614, 648 allowing rapid expansion of liquid refrigerant into a gas form within sealed system cooling device 608 and 609. As the liquid refrigerant boils off heat is absorbed into the gas by transferring heat from housings 616, 650 and liquid and solid CO₂ within housings 616, 650. Refrigerants or mixtures of refrigerants such as Hexafluoroethane, Trifluoromethane, Ethane, Ethylene, Tetrafluoromethane, Methane, Argon, Nitrogen, Neon, Helium, Hydrogen, or any other low boiling point refrigerants may be used. Gas vent 632 may be used to regulate pressure within housing 616 and may be connected to post-combustion gas input 634 to recycle any gas material not in solid or liquid form. Light gases 644 not condensed within bubbler 650 are exhausted as light gas material. The sealed system cooling devices 608 and 609 may help to keep the solid CO₂ or liquid at or below a melting point of the solid CO₂.

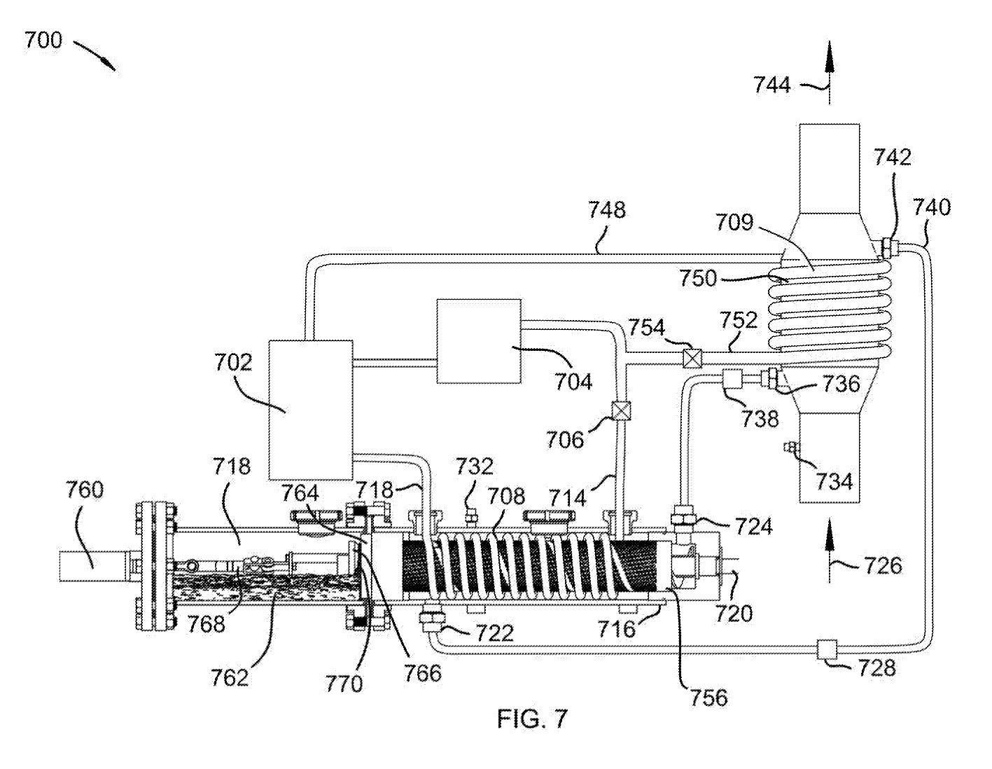

Referring to FIG. 7, in one embodiment, a cryogenic cooler 702 cools a liquid, and pump 704 circulates the cooled liquid through a sealed system cooling device 708 wrapped around filter 756 by way of inlet 714 and outlet 718; and provides cooling to a bubbler tank 750 by way of coil ends 748 and 652 of cooling coil device 709. Bubbler tank 750 may store cooled liquid at or near atmospheric pressures for desublimating flue gasses 726 as bubbled through cooled liquid stored and circulated through Bubbler tank 750 by way of inlet 740 and outlet 736. As post-combustion gases 726 pass through bubbler tank 750, condensable materials within the post-combustion gases 726 are desublimated and discharged through outlet 736 and through slurry pump 738 into inlet 724. Solid CO₂ compactor 716 then separates the solid CO₂ from the liquids and the liquids are cooled by the sealed system cooling device coil wrapped around housing 716 and the cooled liquid returns to the cooled bubbler tank 750. Metering valves 706 and 754 may control a flow of fluid through the cooling coil devices 708 and 709 in thermal contact with the bubbler tank 750 and the solid CO₂ compactor 716. Metering valves 706 and 754 may be electrically controllable or may be a mechanically controlled by spring pressure or by thermostatic capillary force. A flow thorough cooling coil device 708 and 709 may determine a temperature within housing 716, 750 and a temperature of liquid leaving liquid discharge ports 722 and 736. A temperature sensor may be in contact with liquid leaving discharge ports 722 and 736 to provide feedback for pumps 738,728 and metering valves 706 and 754. Sealed system cooling devices 708 and 709 may provide heat transfer from solid CO₂ and/or liquids entering input ports 724 and 742. Housing 716 may be rigidly connected to a pressure vessel 718. Between pressure vessel 718 and housing 716 two tapered surfaces 766 and 764 may form a machined surface of a solid CO₂ pressure regulator. A solid CO₂ pressure regulator may provide back pressure to solid CO₂ compacted by an auger of screw drive 720 as solid CO₂ is pressed into a pressure regulated solid CO₂ discharge port and into pressure vessel 718. Once in pressure vessel 718 solid CO₂ may melt into a liquid 762. An actuator 760 and an actuator arm 768 may provide pressure between tapered surfaces 766 and 764 creating back pressure on solid CO₂ 770 exiting filter 756.

In another embodiment, compressor 702 provides a low pressure to evaporator outlets 718, 748 and provides a compressed hot gas refrigerant to condenser 704. Condenser 704 may transfer heat from the hot gas refrigerant and condense the refrigerant into a cooled liquid refrigerant at metering devices 706, 754. Metering devices 706, 754 may provide a pressure drop into evaporator sealed system cooling devices 708, 709 by way of inlets 714, 748 allowing rapid expansion of liquid refrigerant into a gas form within sealed system cooling device 708 and 709. As the liquid refrigerant boils off heat is absorbed into the gas by transferring heat from housings 716, 750 and liquid and solid CO₂ within housings 716, 750. Refrigerants or mixtures of refrigerants such as Hexafluoroethane, Trifluoromethane, Ethane, Ethylene, Tetrafluoromethane, Methane, Argon, Nitrogen, Neon, Helium, Hydrogen, or any other low boiling point refrigerants may be used. Gas vent 732 may be used to regulate pressure within housing 716 and may be connected to post-combustion gas input 734 to recycle any gas material not in solid or liquid form. Light gases 744 not condensed within bubbler 750 are exhausted as light gas material. Housing 716 may be rigidly connected to a pressure vessel 718. Between pressure vessel 718 and housing 716 two tapered surfaces 766 and 764 may form a machined surface of a solid CO₂ pressure regulator. A solid CO₂ pressure regulator may provide back pressure to solid CO₂ compacted by an auger of screw drive 720 as solid CO₂ is pressed into a pressure regulated solid CO₂ discharge port and into pressure vessel 718. Once in pressure vessel 718 solid CO₂ may melt into a liquid 762. An actuator 760 and an actuator arm 768 may provide pressure between tapered surfaces 766 and 764 creating back pressure on solid CO₂ 770 exiting filter 756.

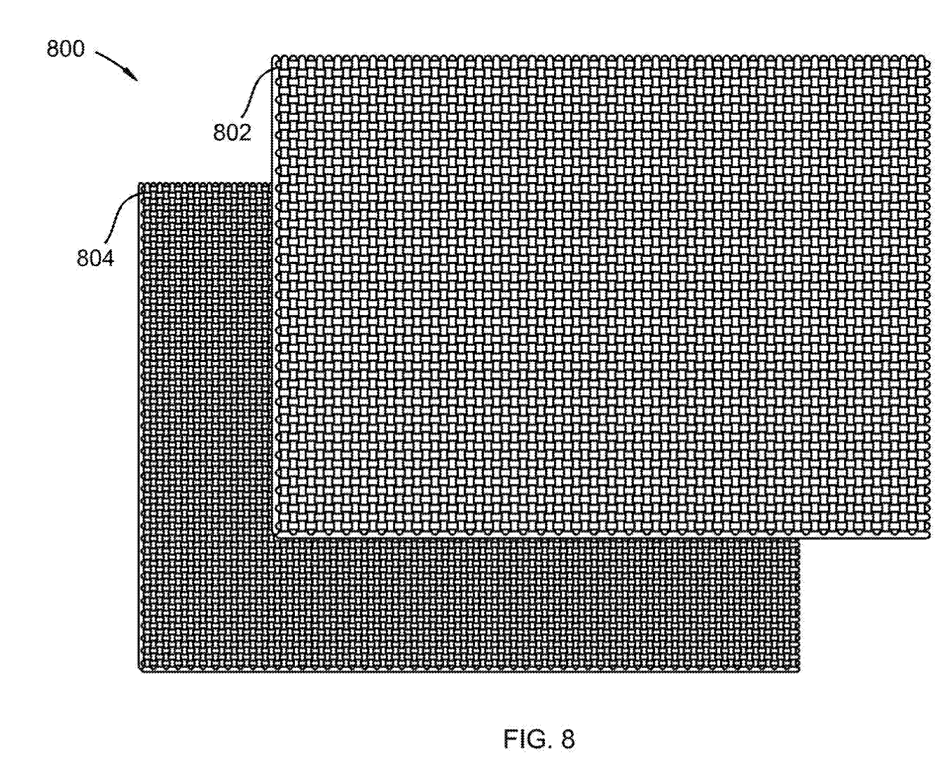

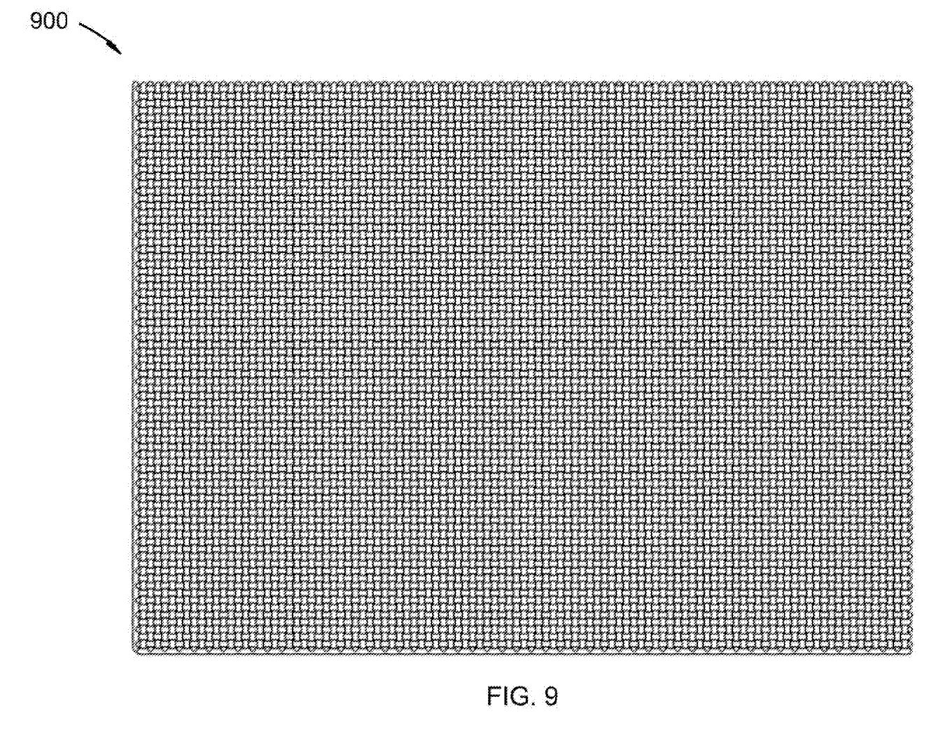

Referring to FIGS. 8 and 9, FIG. 8 shows two or more mesh filters 800. Each mesh filter 804 and 802 have a filtering size smaller than 70 microns. Mesh filters 802 and 804 may be sintered together as shown in FIG. 9. Sintered filter 900 comprises two or more mesh filters sintered together into a single sintered mesh filter. Each of the mesh filters having a mesh filtering size of 70 microns or less.

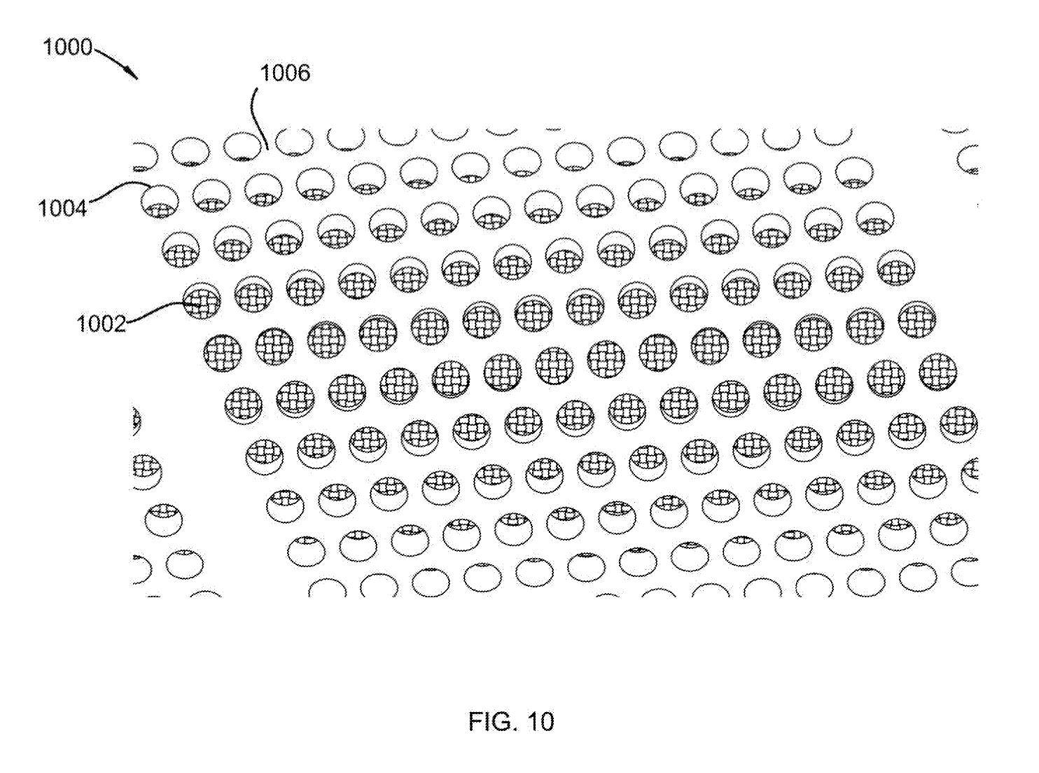

Referring to FIG. 10, a close-up of a filter frame section 1000 is shown. Filter frame material 1006 is a support material for the sintered mesh 1002. Holes 1004 are placed to allow strength to be maintained in frame material 1006. Frame 1006 is designed to withstand pressures up to and exceeding 15 Bar.

1. An apparatus for separating solid CO₂ (carbon dioxide) suspended or entrained in a liquid comprising:
a housing with an interior and an exterior;
a filter located within the interior of the housing;
a compactor contained within the interior of the housing that compacts the solid CO₂ against the filter to form compacted solid CO₂; and
a sealed system cooling device in thermal contact with the liquid, the solid CO₂, the compacted solid CO₂, or the filter within the housing that keeps the solid CO₂ at temperatures below a melting point of the solid CO₂ while the solid CO₂ is being compacted against the filter.

2. The apparatus of claim 1, wherein the sealed system cooling device is at least partially controlled by a temperature of the liquid.

3. The apparatus of claim 1, wherein the sealed system cooling device is at least partially controlled by a pressure within the interior of the housing.

4. The apparatus of claim 1, wherein the sealed system cooling device is at least partially controlled by a pressure of the compacted solid CO₂ and a current consumed by a motor of the compactor.

5. The apparatus of claim 1, wherein the solid CO₂ is compacted against a circular, inner portion of the filter.

6. The apparatus of claim 1, wherein the sealed system cooling device circulates fluid to provide cooling to the liquid.

7. The apparatus of claim 1, wherein the filter is constructed at least partially from one or more of: mesh, stainless steel, metal, ceramic, carbon, fibrous materials, plastic, diamond, or an interstitially formed material.

8. The apparatus of claim 1, the sealed system cooling device assists in keeping the solid CO₂ or liquid at temperatures below −50° C.

9. The apparatus of claim 1, wherein the solid CO₂ is compacted by the compactor using a motor by one or more screws, augers, pistons, tapered wedges, or combinations thereof.

10. The apparatus of claim 1, wherein the filter housing provides a frame which connects an input port to a first side of the filter.

11. The apparatus of claim 1, wherein the sealed system cooling device is located within the interior of the housing.

12. The apparatus of claim 1, wherein the sealed system cooling device is an integral part of the housing.

13. The apparatus of claim 1, wherein the sealed system cooling device is in thermal contact with the exterior of the housing.

14. The apparatus of claim 1, wherein the sealed system cooling device is wrapped around the filter.

15. The apparatus of claim 1, wherein the sealed system cooling device is wrapped around the housing.

16. The apparatus of claim 1, wherein the filter is two or more mesh filters sintered together.

17. The apparatus of claim 16, wherein each of the two or more mesh filters have a filtering size between 70 microns and 2 microns.

18. The apparatus of claim 1, wherein the housing comprises a gas discharge port

19. The apparatus of claim 18, wherein the gas discharge port at least partially controls a pressure within the housing.

20. The apparatus of claim 18, wherein the gas discharge port feeds into a process gas input.
